(19) United States
(12) Patent Application Publication
(10) Pub. No.: US 2009/0114071 A1
(43) Pub. Date: May 7, 2009

(54) Rotating Stamping Apparatus for Stamping Blanks with a Defined Geometry and Size from a Flat Structure and Method of Use

(76) Inventor: Franz-Joseph Mardian, Hinterweidenthal (DE)

Correspondence Address: GOODMAN, ALLEN & FILETTI PLLC, 4501 HIGHWOODS PARKWAY, SUITE 210, GLEN ALLEN, VA, 23060, US

(21) Appl. No.: 12/300,133

(22) PCT Filed: May 11, 2006
(86) PCT No.: PCT/DE06/00811

§ 371 Date: Nov. 10, 2008

(51) Int. Cl. B26F 1/38; B26F 1/44

(52) U.S. Cl. 83/113; 83/347

(57) ABSTRACT

An apparatus for rotational stamping of stamped blanks with a defined geometry and size from a flat material comprises a tool, which comprises plural cutting dies and cutting holes. A first tool support rotates about a first axis and a second tool support rotates about a second axis. The first axis and the second axis are disposed in parallel and at a radial distance from one another, so that a radial offset for forming a pass-through gap for the flat material is provided between the first tool support and the second tool support. The cutting dies penetrate the cutting holes precisely fitting through counteracting rotation of the tool supports. The invention provides that the cutting dies and the cutting holes are disposed respectively on the circumference of the first tool support and on the circumference of the second tool support, in a seamless and alternating pattern, so that the flat material is processed into stamped blanks in a single step without lost or scrap pieces.

### CROSS-REFERENCE TO RELATED APPLICATIONS

This application is a continuation of International Application No. PCT/DE06/00811, filed May 11, 2006. The disclosure of this application is incorporated herein by reference.

### BACKGROUND OF THE INVENTION

This invention relates in general to a rotating stamping apparatus for stamping blanks.

In many technical fields, stamped components of a defined size are required, which are made of materials like glass, ceramic or carbon material. For producing fibers comprising a defined length, suitable industrial methods and apparatuses have been developed. Thus, U.S. Pat. No. 4,638,934 discloses an apparatus for cutting fiberglass mats into small pieces. For this purpose, the fiberglass mats are initially cut into longitudinal strips by the rolling knives. The longitudinal strips are subsequently cut in a transversal direction. During the cutting processes, the fiberglass mat rests on an elastic cutting surface.

U.S. Pat. No. 3,921,874 describes another method and a suitable apparatus. In this publication, long threads of base material are submerged in a liquid, which is subsequently solidified through cooling. The frozen fiber strand is subsequently cut in transversal direction. After cooling and removing the liquid, short fibers are provided.

The disadvantage of the known method and apparatus is that a slippage can occur between the first and the second cutting process, so that the finished product can have different lengths. The method disclosed in the second U.S. publication furthermore only has a limited capacity and is thus less suitable for mass production.

The genus defining document DE 203 06 090 U1 describes an apparatus for rotating stamping of stamped pieces from extruded endless profiles, in particular for embossing and punching of endless profiles coming out of an extruder, wherein, however, stamping residuals are left over, which limit the productivity of the process.

### SUMMARY OF THE INVENTION

This invention relates to an apparatus for rotational stamping of blanks with a defined geometry and size from a flat material. The apparatus comprises a tool that comprises plural cutting dies and cutting holes. A first tool support rotates about a first axis and a second tool support rotates about a second axis. The first axis and the second axis are disposed in parallel and at a radial distance from one another, so that a radial offset for forming a pass-through gap for the flat material is provided between the first tool support and the second tool support. The cutting dies penetrate the cutting holes fitting through counteracting rotation of the tool supports. The cutting dies and the cutting holes are disposed on the circumference of the first tool support and on the circumference of the second tool support in a seamless and alternating pattern, so that the flat material is processed into stamped blanks in a single step without lost or scrap pieces.

Various advantages of this invention will become apparent to those skilled in the art from the following detailed description of the preferred embodiment, when read in light of the accompanying drawings.

### BRIEF DESCRIPTION OF THE DRAWINGS

Embodiments of the invention are described in more detail in the subsequent description with reference to the drawing figures, wherein:

FIG. 1 shows a frontal sectional view of an apparatus for rotational stamping of stamped blanks, cut along the line I.

FIG. 2 shows a lateral view of the apparatus according to FIG. 1;

FIG. 3 shows a sectional frontal view of an apparatus for rotational stamping of stamped blanks according to another embodiment of the invention; and

FIG. 4 shows a frontal view of annular ribs of the apparatus according to FIG. 3.

### DETAILED DESCRIPTION OF THE PREFERRED EMBODIMENT

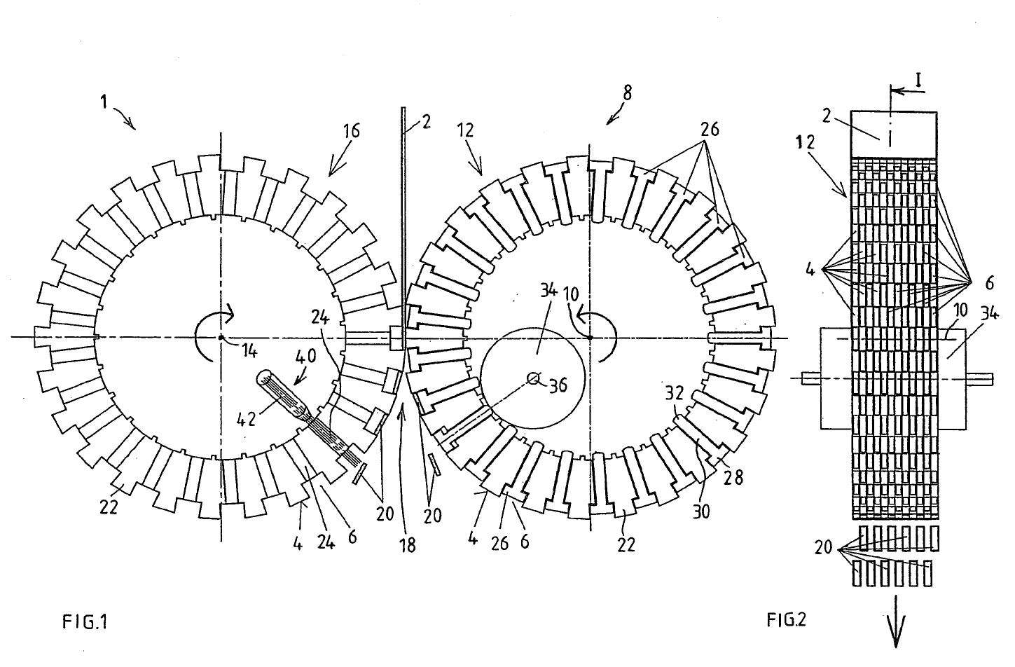

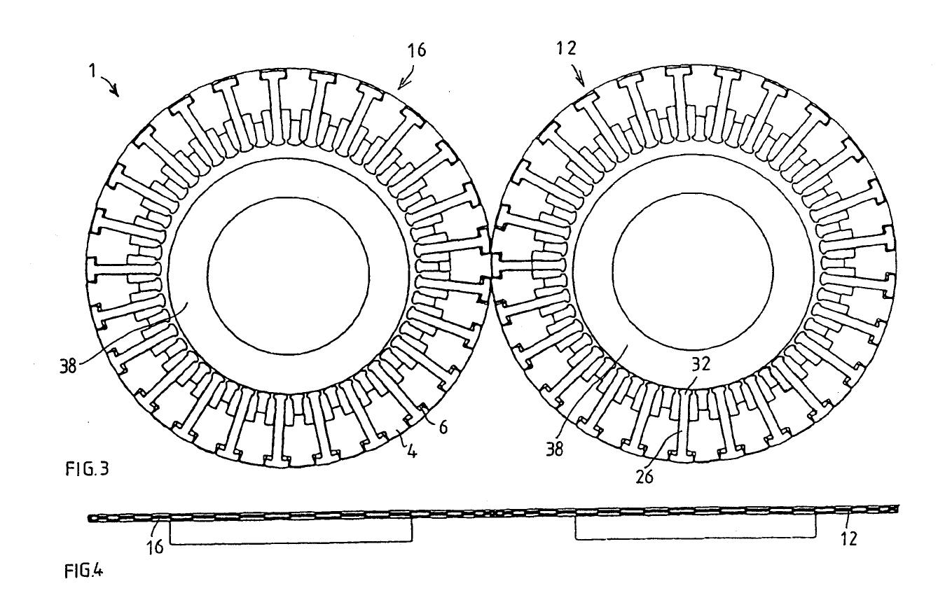

Referring now to the drawings, there is illustrated in FIG. 1 an apparatus designated with the reference numeral 1 for rotational stamping of stamped blanks with defined geometry and size from a flat material 2.

The apparatus 1 comprises a tool 8, comprising plural cutting dies 4 and cutting holes 6, wherein the tool comprises a first tool support 12 rotating about a first axis 10, wherein the tool support is configured as a drum, and the tool comprises a second tool support 16, which is also drum shaped and rotates about a second axis 14. Thus, the first axis 10 and the second axis 14 are parallel, co-planar and disposed with a radial offset from one another, so that a radial offset for forming a pass-through gap 18 for the flat material 2 is provided between the first tool support 12 and the second tool support 16 and the cutting dies 4 penetrate the cutting holes 6, precisely fitting through the counteracting rotation of the two tool supports 12, 16 similar to gears meshing with one another.

When the cutting dies 4 penetrate the cutting holes 6, a stamped blank 20, which corresponds to the cross section of the cutting die 4 or of the corresponding cutting hole 6, is stamped out of the flat material 2 and pressed into the cutting hole 6, wherein a friction locking between the rim of the stamped blank and the wall of the cutting hole occurs, depending on the tolerances and the elastic properties of the material of the flat material, wherein the friction locking tends to hold the stamped blank 20 in the cutting hole 6.

In a particularly preferred manner, the cutting dies 4 and the cutting holes 6 are configured, so that only stamped blanks 20 with identical geometry and size are stamped out, thus e.g. rectangular stamped blanks. As can be seen from FIG. 2, the cutting dies 4 and the cutting holes 6 are disposed in an alternating seamless checkerboard pattern in circumferential direction and also in axial direction on the circumference of the tool support 12, 16, so that the flat material 2, whose width does not extend beyond the width of the tool supports 12, 16, is converted into stamped blanks 20 completely and without residual.

The tool supports 12, 16 each carry respective identical annular ribs 22 with cutting dies 4 and cutting holes, configured at their circumference in a seamless and alternating pattern, wherein the annular ribs are stacked in axial direction and respectively offset in circumferential direction by a pitch, so that cutting dies and cutting holes 6 also alternate in a seamless pattern in axial direction. The thickness of the annular ribs 22 thus is identical to the width of the stamped blanks 20. For reasons of clarity, the sectional view of FIG. 1 only illustrates two annular ribs 22 of the two tool supports 12, 16, wherein the annular ribs mesh with one another. The annular ribs 22 can e.g. be received on a hub of the respective tool support 12, 16, so they contact one another in axial direction, and they can be connected to the hub, e.g. through a teething, that they are at least rotationally fixed.

The annular ribs 22 are preferably comprised of steel, which is hardened or case hardened or provided with a wear resistant layer, e.g. made of hard metal, in particular in the portions of the cutting dies 4 and/or of the cutting holes 6. Due to their wear resistance, ceramic materials can be used for the annular ribs 22, e.g. in the form of a coating in the portion of the cutting dies 4 and/or of the cutting holes 6.

In a particularly preferred manner, the channels 24 extend from the inner circumference of the annular ribs 22 into the cutting holes 6.

According to a variant shown on the right side of FIG. 1, ejectors 26 can be guided in a radially movable manner in the channels 24 of the annular ribs 22, wherein the ejectors are preferably configured as T-shaped flat elements, comprising a transversal bar 28, disposed in a cutting hole 6, contacting the stamped blanks 20, a shaft 30 guided in the channel 24 and a base portion 32, protruding from the channel 24 in radially inward direction. Furthermore, a roller 34 can be eccentrically disposed in the interior of the packet of annular ribs, so that the roller engages the base portion 32 of at least one ejector 26, depending on the rotation position of the tool support 12, thus forcing it to the radial outside, which ejects the stamped blank 20, which is disposed in the associated cutting hole 6, and held therein through friction locking, preferably in downward direction following gravity. The axis of the roller 34 is thus parallel to the axis 10 of the first tool support 12. The roller 34 furthermore comprises an exterior diameter, which is smaller than the inner diameter of the inner circumference of the annular ribs 22.

For radial actuation of the ejectors 26, the roller 34 is eccentrically supported at a fixed axle 36 in the interior of the rotating tool support 12 according to the embodiment on the right side of FIG. 1, wherein the axle 36 is preferably disposed in the quadrant of the tool support 12, subsequent to the pass-through gap 18 in rotation direction. Due to the rotating drive of the tool support 12 and due to the three-dimensionally fixated rotation support of the roller 34, the base portions 32 of all ejectors 26 contact the surface of the roller in the course of a complete rotation of the tool support 12, and are thus forced to the radial outside, which causes an ejection of the stamped blanks 20 from the cutting holes 6 of the tool support 12. When the ejectors 26 are rotated into the two upper quadrants, or through the penetration of the cutting dies 4 of the other tool support 16 into the associated cutting holes 6, the ejectors 26 are moved back into their starting position on the radial inside by gravity. In order to prevent a fallout of the ejectors 26 from the channels 24, the cross section of the base portions 32 can be expanded relative to the shafts 30.

According to another embodiment according to FIG. 3, such a parallel roller 38 can also be loosely supported in the interior of a tool support 12, 16, so that it can contact the base portions 32 of the ejectors 26 due to gravity. The roller 38, in turn, comprises a smaller outer diameter than the inner diameter of the inner circumference of the annular ribs 22, and follows for a certain distance in rotation direction due to being driven by the tool support 12, 16, and then reverts back into its lower starting position due to gravity, or it rolls about the starting position in an oscillating manner, which facilitates a radial actuation of the ejectors 26, due to the occurring dynamic forces.

According to another embodiment illustrated on the left side of FIG. 1, a pressure generation apparatus 40 can be provided, which imparts the static pressure of a pressure means upon at least one channel 24 from the radial inside for ejecting the stamped blanks 20, wherein the pressure means preferably comprises water. For injecting the pressure means into the channel 24, e.g. at least one nozzle 42 can be provided, which can be aligned with a channel 24, depending on the rotation position of the tool support 16. Generally, thus, the ejection of a stamped blank held in a cutting hole 6 through force locking depends on the rotation position of the tool support 12, 16.

According to an embodiment, which is not shown here, a respective elastic element can be held in the cutting holes 6, e.g. provided as a rubber piece, which is compressed in a spring elastic manner, when the cutting die 4 penetrates the respective cutting hole 6, and which expands again after the cutting die 4 has retracted from the cutting hole 6, which ejects the stamped blank 20 held in the cutting hole 6.

The apparatus described above is used for stamping stamped blanks 20 with a defined geometry and size, preferably made of leather, fibrous layups or foils, without loss or residual pieces, wherein the fibrous layups are preferably provided as layups, cloths, paper, nonwoven materials or felts, and are comprised of natural fibers, synthetic fibers, glass or carbon fibers, with and without binder, and the foil is comprised e.g. of plastic, metal or expanded graphite.

In a preferred manner, fibrous materials, preferably carbon fibers, are used for the flat materials 2, which are provided with additives and/or a curable binder. The flat material can be provided in the form of sheets with one layer or with plural layers.

In a particularly preferred manner, stamped blanks 20 with a thickness of 5 μm to 5 mm, and a width of 0.1 mm to 10 mm, and a length 1 mm to 100 mm can be produced by the apparatus.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. An apparatus for rotational stamping of stamped blanks with a defined geometry and size from a flat material, wherein said apparatus comprises a tool, comprising plural cutting dies and cutting holes, and comprises a first tool support rotating about a first axis and a second tool support rotating about a second axis, wherein the first axis and the second axis are disposed in parallel and at a radial distance from one another, so that a radial offset for forming a pass-through gap for the flat material is provided between the first tool support and the second tool support, and the cutting dies penetrate the cutting holes fitting through counteracting rotation of the tool supports, wherein the cutting dies and the cutting holes are disposed on the circumference of the first tool support and on the circumference of the second tool support in a seamless and alternating pattern, so that the flat material is processed into stamped blanks in a single step without lost or scrap pieces.

2. An apparatus according to claim 1, wherein the cutting dies and the cutting holes are configured, so that only stamped blanks with identical geometry and size are stamped out.

3. An apparatus according to claim 1, wherein the cutting dies and the cutting holes are disposed in an alternating checkerboard pattern on the circumferences of the tool supports in direction and also in axial direction.

4. An apparatus according to claim 3, wherein the tool supports comprise annular ribs, comprising cutting dies and cutting holes, configured on their circumferences in a seamless and alternating pattern, wherein said cutting dies and cutting holes are stacked in axial direction and offset with respect to one another by a pitch, so that the cutting dies and the cutting holes also alternate in a seamless pattern in axial direction.

5. An apparatus according to claim 4, wherein the thickness of the annular ribs is identical to the width of the stamped blanks to be stamped.

6. An apparatus according to claim 5, wherein channels extend from the inner circumferences of the annular ribs into the cutting holes.

7. An apparatus according to claim 4, wherein channels extend from the inner circumferences of the annular ribs into the cutting holes.

8. An apparatus according to claim 7, wherein ejectors are guided in the channels, so they are movable in radial direction.

9. An apparatus according to claim 8, wherein the ejectors are T-shaped flat elements, comprising a transversal bar, disposed in the cutting hole and contacting the stamped blanks, a shaft guided in a channel, and a base portion, radially protruding in inward direction from the channel.

10. An apparatus according to claim 9, wherein the cross sections of the base portions of the ejectors are expanded relative to the shafts.

11. An apparatus according to claim 9, wherein at least one respective roller is eccentrically disposed in the interiors of the tool supports, so that it contacts the base portion of at least one ejector, depending on the rotation position of the tool support, thus forcing said ejector in radial outward direction.

12. An apparatus according to claim 11, wherein a roller is loosely supported in the interior of at least one rotating tool support, so that it contacts the base portions of the ejectors due to gravity.

13. An apparatus according to claim 11, wherein a roller is eccentrically supported at a fixed axle in the interior of at least one rotating tool support.

14. An apparatus according to claim 9, wherein at least one respective roller is eccentrically disposed in the interiors of the tool supports, so that it contacts the base portion of at least one ejector, depending on the rotation position of the tool support, thus forcing said ejector in radial outward direction.

15. An apparatus according to claim 7, wherein a pressure generation apparatus is provided, which pressurizes at least some of the channels through a pressure means.

16. An apparatus according to claim 15, wherein the pressure means comprises water.

17. An apparatus according to claim 15, wherein at least one nozzle is provided, which can be aligned with at least one channel, depending on the rotation position of the tool support, in order to feed the pressure means.

18-20. (canceled)
